(19) United States
(12) Patent Application Publication
(10) Pub. No.: US 2024/0320638 A1
(43) Pub. Date: Sep. 26, 2024

(54) RESIDENTIAL VEHICLE CHARGING SYSTEM WITH INTERPERSONAL PAYMENT OPTION

(71) Applicant: FCA US LLC, Auburn Hills, MI (US)

(72) Inventor: Kenneth P. DeGroot, Macomb Township, MI (US)

(21) Appl. No.: 18/189,633

(22) Filed: Mar. 24, 2023

(51) Int. Cl. G06Q 20/10; B60L 53/66; B60L 53/68; G06Q 20/08; G06Q 20/14; G06Q 50/06

(52) U.S. Cl. CPC G06Q 20/102; B60L 53/665; B60L 53/68; G06Q 20/0855; G06Q 20/145; G06Q 50/06

(57) ABSTRACT

A vehicle charging system includes a power supply connected to the electrical system of a personal residence, the power supply including a charging station adapted to be connected to a vehicle to permit charging of a power storage unit in the vehicle. The system also includes a power meter adapted to determine an amount of electricity used to charge the vehicle in a charging session, and a communication device to connect with a remote electronic device. The communication device has a transmitter and a receiver to transmit and receive information from the remote electronic device, and the communication device has a control interface by which the payment information is adapted to be transferred to transfer funds to a recipient as a function of the amount of electricity used to charge the vehicle.

### FIELD

The present disclosure relates to a vehicle charging system at a residence and which includes an interpersonal payment option.

### BACKGROUND

Unlike liquid fuels used by vehicles having an internal combustion engine, electricity is readily available at many residences. So, where it would be rare for a residence to have the ability to refill a vehicle gas tank, it will not be rare for a residence to be able to provide electrical energy to recharge a vehicle's batteries. Of course, the energy transferred from the residence to the vehicle comes at some cost to the owner of the residence (or other person responsible for the electric bill). Residential charging stations or power supplies do not include interfaces for payment via credit card or otherwise and determining an amount of electricity involved in a charging session, and a monetary amount therefore, can be impossible for an owner of the residence to do accurately.

### SUMMARY

In at least some implementations, a vehicle charging system, includes a power supply connected to the electrical system of a personal residence, the power supply including a charging station adapted to be connected to a vehicle to permit charging of a power storage unit in the vehicle. The system also includes a power meter adapted to determine an amount of electricity used to charge the vehicle in a charging session, and a communication device adapted to connect with a remote electronic device. The communication device has a transmitter that provides an output indicative of the amount of electricity used to charge the vehicle in the charging session, the communication device has a receiver adapted to receive information from the remote electronic device, and the communication device has a control interface by which the payment information is adapted to be transferred to transfer funds to a recipient as a function of the amount of electricity used to charge the vehicle.

In at least some implementations, the power supply is an electrical system of a residence. In at least some implementations, the power meter is part of a charging station at the residence. In at least some implementations, the power meter is part of the electrical system of the residence. In at least some implementations, the control interface is adapted to communicate with a third-party payment service to permit a transfer of funds to the payment recipient device via the third-party payment service. In at least some implementations, the control interface includes a controller and memory including instructions for communication with the remote electronic device and the third-party payment service. In at least some implementations, the third-party payment service includes a credit card, debit card, digital wallet or peer-to-peer payment service.

In at least some implementations, the system also includes a remote system having a backend portion configured to communicate with the communication device for exchange of information between the communication device and the backend portion. In at least some implementations, the remote system having the backend portion is part of a secure, cloud-based network adapted to communicate with the communication device to receive information from the communication device about a charging session.

In at least some implementations, a method of determining and effecting payment for use of a personal vehicle charging station, includes steps of determining an amount of electricity used to charge the vehicle power storage system in a charging session, determining a monetary amount for the amount of electricity used to charge the vehicle power storage system in the charging session, requesting from a remote electronic device payment of the monetary amount, providing an interface for payment of the monetary amount from the remote electronic device to a recipient.

In at least some implementations, the interface includes one or more of a credit card portal, debit card portal, digital wallet portal or peer-to-peer payment service. In at least some implementations, the step of determining an amount of electricity used to charge the vehicle power storage system in a charging session is accomplished by connection of a remote electronic device with a power meter, where the power meter provides to the remote electronic device an output indicative of the amount of electricity used to charge the vehicle power storage system in a charging session.

In at least some implementations, the step of determining a monetary amount for the amount of electricity used to charge the vehicle power storage system in the charging session is accomplished by reference to an established cost for the electricity used to charge the vehicle power storage system in the charging session. In at least some implementations, the established cost may be stored in a memory device, available in a remote database, or entered manually into a device used to determine the monetary amount. In at least some implementations, the device used to determine the monetary amount includes a mobile phone, tablet or personal computing device. In at least some implementations, the interface is provided on the mobile phone, tablet or personal computing device. In at least some implementations, the interface permits manual entry of the monetary amount.

In at least some implementations, the power meter is a vehicle control system that controls the rate at which charging of the vehicle power storage system occurs, and wherein the remote electronic device is communicated with the vehicle control system. In at least some implementations, the remote electronic device is connected with the vehicle control system via a wireless local area network or by a wired connection of the device to a port of the vehicle.

The systems and method permit payment for a charging session that occurs via a charging station or other power supply that is not configured for direct payment. For example, the power supply does not include a credit card reader or the like for direct payment for use of the power supply. In this way, a fair monetary amount may be charged by and paid to an owner of the power supply for use of the power supply and the electricity provided to a vehicle during a charging session. This will enable, for example, homeowners to recoup some or all of the cost associated with a charging session for a vehicle owned or controlled by someone else. A company may provide charging stations for installation in a residence, and remote systems to interface with the charging stations and facilitate payment for charging sessions, as desired by an owner of the residence.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a noncommercial charging station 20 including devices to determine a cost for a charging session and to enable electronic payment for the charging session; and

FIG. 2 is a flowchart of a method of determining a cost and effecting payment for a charging session.

### DETAILED DESCRIPTION

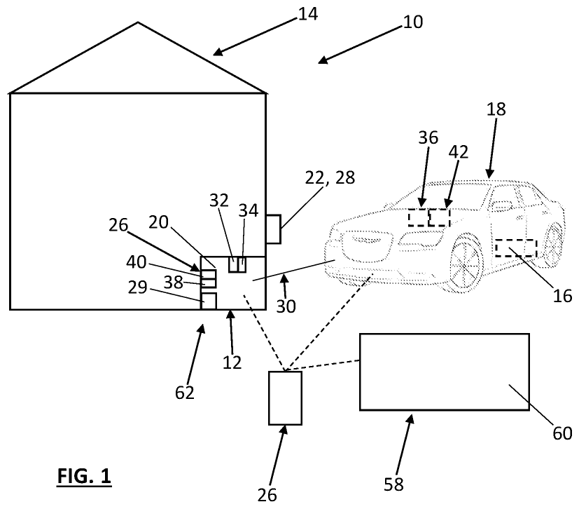

Referring in more detail to the drawings, FIG. 1 illustrates a residential vehicle charging system 10 that enables a transfer of energy from a power supply 12 of a residence 14 to a power storage unit 16 of a vehicle 18. The power supply 12 of the residence 14 may include an electrical outlet or a dedicated vehicle charging station 20 installed at the residence, for example, and connected to an electrical system at the residence. To charge the vehicle's power storage unit 16 (e.g. batteries), the vehicle 18 is connected to the power supply 12 and electricity from the electrical system of the residence 14 is provided to the vehicle 18.

As more electric vehicles and hybrid vehicles including electric powertrains are sold, it will become more commonplace for a person to have to or want to charge their vehicle's batteries at someone else's residence. Unlike liquid fuels used by vehicles having an internal combustion engine, electricity is readily available at many residences. So, where it would be rare for a residence to have the ability to refill a vehicle gas tank, it will not be rare for a residence 14 to be able to provide electrical energy to recharge a vehicle 18. Of course, the energy transferred from the residence 14 to the vehicle 18 comes at some cost to the owner of the residence (or other person responsible for the electric bill). To simplify the disclosure of the system herein, the person responsible for the electric bill will be assumed to be the owner of the residence 14, where reference to the owner of the residence 14 should be understood to include anyone responsible for an electrical bill of the residence or to whom payment for such electricity is desired to be made in exchange for the electricity used to charge a vehicle 18.

The vehicle charging system 10 set forth herein provides an interface by which someone can pay the owner of a residence 14 for energy used to recharge an electric vehicle's power storage unit 16. In at least some implementations, the vehicle charging system 10 includes or is communicated with a power meter 22 that determines an amount of electricity used to charge the vehicle 18 in a charging session and a communication device 24 that is adapted to connect with a remote electronic device 26, such as a phone, tablet or computer to permit a transfer of funds to the owner of the residence.

In at least some implementations, as shown in FIG. 1, the power meter 22 may be a residence-based device or a vehicle-based device. An example of a residence-based device is a meter 28 installed at the residence 14 to enable determination of electrical use of the entire residence 14, not just the power supply 12 by which the vehicle is coupled to the residential electrical system (e.g. the outlet or vehicle charging station 20 at the residence).

A residence-based power meter 29 could instead be a feature or component of the charging station 20, which may be a self-contained device installed at the residence and coupled to the residence's electrical system. The charging station 20 provides a desired interface for a vehicle 18, such as a cord 30 with a plug or adapter for connection to a vehicle, and it is anticipated that wireless charging interfaces may be available in the future. The charging station 20 may include a controller 32 and circuitry 34 including, for example, one or more fuses, one or more sensors, like a temperature sensor, a current sensor or meter, and related componentry to permit controlled transfer of electricity through the device to a vehicle 18. The charging station-based power meter 22 may monitor current flow through the charging station 20 and to the vehicle 18.

The power meter 22 could instead be vehicle-based, that is, installed in the vehicle 18 and may enable a charge level determination in different ways. The vehicle-based power meter 22 may be part of a vehicle control system 36 that monitors or controls the rate of charging, the amount of charging, the battery discharge rate, temperature of the power storage unit 16/batteries, or the like. That is, the power meter may be already provided within the vehicle control system 36 for the normal operation of the vehicle 18 and not as a separate, dedicated meter to determine electrical use during a charging session. The vehicle-based power meter may provide information in different ways, for example by percent of battery capacity at the start of the charging session compared to the ending battery capacity percent, by units of electricity stored/charged in the vehicle (e.g. kilowatt hours), as desired. A different or further power meter 22 may be time-based with the duration of a charging session used to determine the electrical usage of the charging session based upon an average or assumed rate of charging. A time-based power meter 22 may be part of the residence, the vehicle and/or the remote electronic device 26.

To permit communication of information relating to the charging session, including data or information from the power meter 22, the communication device 24 may be adapted to connect with a remote electronic device 26 and the communication device 24 has a transmitter 38 that provides an output indicative of the amount of electricity used to charge the vehicle 18 in the charging session. In at least some implementations, the communication device 24 is a component within the charging station 20. In an implementation where the power meter 22 is within the charging station 20, the communication device 24 is directly connected to the power meter 22 within the charging station 20. In this regard, the charging station 20 includes a controller 32 that receives information from the power meter 22 and provides that information to the communication device 24 for transmission of the information to the remote electronic device 26. In an implementation where the power meter 22 is a residence-based power meter 22 responsive to use of electricity in the residence 14 in general, a transmission device 38 may be provided on or associated with the power meter 22 to permit transmission of information regarding electricity usage to the communication device 24. In such a system, the communication device 24 includes a receiver 40 to receive information from the transmission device.

In an implementation where the power meter 22 is vehicle-based, the communication device 24 may connect with a vehicle human-machine interface (HMI) 42 to permit information regarding the charging session to be communicated from the vehicle 18 to the communication device 24. The vehicle interface/HMI 42 may be part of or driven by the vehicle control system 36 and may include a display screen on which various information may be provided and various selectable options may be provided for selection by a user in any desired manner (e.g. touchscreen, buttons, joystick, dial, etc). The connection may occur in any desired manner, such as a LAN including NFC, wifi, bluetooth or via a telematics unit of the vehicle. In at least some implementations, a phone or other electronic device of the vehicle owner or passenger may be paired with the vehicle HMI 42 and the electronic device 26 may define the communication device 24 or the electronic device 26 may be connected with a communication device 24 of the charging station 20 to provide information about the charging session. In such a system, the communication device 24 includes a receiver 40 to receive information from the vehicle or the electronic device.

Additionally, the communication device receiver 40 may be adapted to receive payment information from the remote electronic device 26 and/or from a vehicle interface 42 from which a user may make selections (e.g. navigate menu options, enter payment information or approve payment via previously entered payment information. In at least some implementations, the communication device 24 may act as a pass-through device or gateway for a payment service provider, which may be a credit card, debit card/bank interface, digital wallet, or a peer-to-peer payment service (e.g. PayPal, Venmo, CashApp, Zelle or the like), by way of a few examples. That is, the communication device 24 may be or include a control interface for payment, and direct or connect a user via a third-party interface on the remote electronic device 26 of vehicle interface to a website via which payment may be made to an account of a person for the electricity used in a charging session. In at least some implementations, the control interface occurs via an application stored on the remote electronic device 26 or vehicle interface 42, where the application provides or connects a user to an interface for such payment, which payment is transferred to an account of the desired recipient.

In at least some implementations, such an application on a remote device 26 or vehicle interface 42 may be used without direct connection to a communication device 24 of a charging station 20, and may be initiated by a person involved in the transaction to effect payment. The application may receive input data, for example the amount of electricity involved in the charging session, by direct user entry, or by connection with the charging station 20 communication device 24 and/or vehicle interface system.

The device including the control interface includes a controller and memory to execute the application or instructions for communication with the remote electronic device 26 and the third-party payment service. The application may be configured to calculate the monetary amount due to be paid, and then to direct or link a user to a third-party payment service for payment of the determined monetary amount. In this regard, the monetary amount may be a function of a predetermined cost per electrical unit, where the predetermined cost may be entered manually, or based upon a cost schedule located in the memory or obtainable from a remote source (e.g. a remote database or memory in which cost information is stored). The predetermined cost may be an actual cost of an electrical unit determined by reference to a remote source of information as to the real-time cost of electricity to the residence. For example, a utility company may charge different rates for electricity at different times of the day or on different days or other time periods, and the application may be configured to determine the real-time cost per electrical unit, and then with information as to the number of electrical units used (e.g. from a power meter 22) in the charging session, can determine the monetary amount to be paid. Of course, the monetary amount may be determined in different ways.

In at least some implementations, a home charging station 20 does not include any interface for direct payment for use of the charging station 20 and electricity during a charging session. That is, the charging station 20 does not include a device by which a credit card can be read and a charge made directly against the credit card account, nor does the charging station 20 include a user interface by which payment information can be directly entered into the charging station 20 (e.g. no keypad, or touch screen by which such information can be directly entered). Instead, the transaction may occur between people with an application on a remote electronic device 26 configured to collect information about the amount of electricity used and to provide an interface for electronic payment from one person to the other.

Within the system, a method of determining and effecting payment for use of a personal vehicle charging station 20 can be enabled. The system can use real-time information regarding not only the actual cost of electricity during a charging session, but the amount of electricity used among other things.

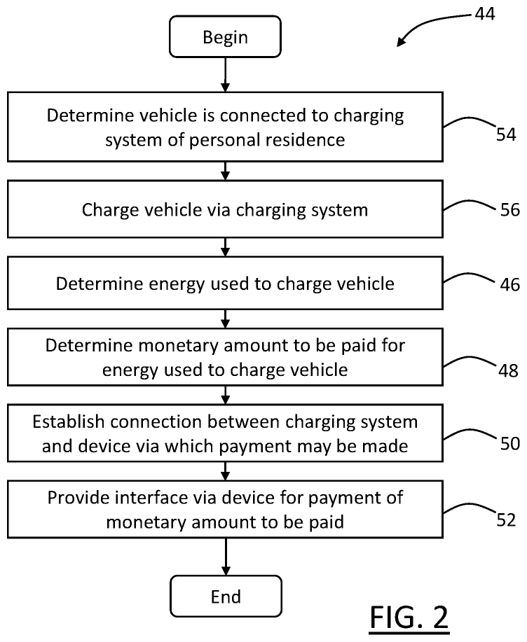

In at least some implementations, a method 44 as shown in FIG. 2, for a charging system 10 coupled to an electrical system of a personal residence and by which a vehicle power storage system may be charged, includes a step 46 of determining an amount of electricity used to charge the vehicle power storage system in a charging session, a step 48 of determining a monetary amount for the amount of electricity used to charge the vehicle power storage system in the charging session, a step 50 in which a connection is established with a remote electronic device 26 for payment of the monetary amount, and a step 52 of providing an interface for payment of the monetary amount from the remote electronic device 26 to a recipient (e.g. the owner of the residence 14).

In at least some implementations, the interface is adapted to permit payment via one or more of a credit card portal, debit card portal, digital wallet portal or peer-to-peer payment service. The portals may be online/internet-based and used via a browser or suitable application, in known manner. In this way, a user may be presented with options as to payment format and an electronic payment can be effected via the remote electronic device 26. Of course, a HMI 42 of the vehicle 18 may also be used to effect such payment, for example with HMI presented options for selection by a user or enabling user input of information via one or more inputs (e.g. buttons, voice command, touch screen or the like). In such an example, the vehicle may have a telematics unit connectable as needed to send or receive information regarding the system and payment as noted herein, via cellular network, wifi (e.g. connected via internet service available at the residence 14 or the like).

In at least some implementations, the amount of electricity used to charge the vehicle power storage system 16 in a charging session is determined by connection of a remote electronic device 26 with a power meter 22 so that the power meter 22 can provide to the remote electronic device 26 an output indicative of the amount of electricity used to charge the vehicle power storage system in a charging session. The connection may be via a wired or wireless connection, and the power meter 22 may be any device for determination of electricity used in a charging session, as noted herein.

In at least some implementations, as shown in FIG. 2, the method 44 for use of the charging system 10 may also include a step 54 of determining that a vehicle is connected to a charging system 10, as described herein, and step 56 of allowing a charging session to occur, where the electricity used may be tracked from the beginning of the charging session. Thereafter, as noted above, an amount of energy used in the charging session is determined, a monetary amount for the charging session, and then payment of the monetary amount is requested or managed via an interface by which a user may electronically pay the monetary amount.

In at least some implementations, the payment is made directly to a predetermined account via a remote interface 58 (FIG. 1), which may be a third-party service interface, as noted herein. The payment may also be made to an account selected at the time of the transaction, such as by selection among options provided by the interface, and payment may be made to a third-party service provider where the third-party then transfers money to an account holder in a prescribed manner. For example, the third-party service provider may send a check to a person, or effect an electronic payment to an account of the person.

In at least some implementations, the vehicle manufacturer or a company associated therewith, may have a remote interface 58 implemented as a secure internet/cloud-based interface 58 established to manage such payments, with a backend, remote portion 60 to which individual charging stations may be connected when a payment transaction is desired. A frontend portion 62 of the system 58 may include the charging station 20 and a communication device 24 therein, and in at least some implementations, an application on a remote electronic device 26, which may also or instead of the charging station 20 communication device 24 connect to the backend portion 60 to perform a payment transaction. The backend portion 60 may include any suitable combination of software and/or hardware resources typically found in a backend 60 of a cloud-based system, as shown in FIG. 1, and is generally responsible for receiving and analyzing payment requests and payment information (credit or debit card or related account information, or peer-to-peer account information, etc.). The backend portion 60 may also include software to determine the monetary amount as a function of the energy used during a charging session, which may be obtained from a power meter 22 or from information entered by a user via the frontend portion. In this way, the entire system 58 from the charging station 20 to the payment interface and payment transaction may be controlled by an entity to provide a full solution, easily implemented and used by its customers.

In the method, and as noted herein, in at least some implementations the monetary amount for the amount of electricity used to charge the vehicle power storage system in a charging session is accomplished by reference to an established cost for the electricity used to charge the vehicle power storage system in the charging session. The established cost may be fixed or set amount, or the established cost may be a real-time cost of the electricity dependent upon the location of the charging stating and the cost of electricity in the location at the time and for the duration of the charging station 20, where the electricity cost in the location may vary over the duration of a charging session. In at least some implementations, the established cost may be stored in a memory device, available in a remote database such as at the backend portion, or entered manually into a device used to determine the monetary amount.

In at least some implementations, the device used to determine the monetary amount includes a mobile phone, tablet or personal computing device which includes software configured to calculate the monetary amount. The software may provide a desired user interface to facilitate the transaction and provide information to the user about, for example, the total energy used in the charging session and the determined monetary amount due for the charging session. The remote electronic device 26 may be connected with the vehicle control system 36 or with the charging station 20 communication device 24 via a wireless local area network or by a wired connection of the device to a port of the vehicle or charging station 20 equipment.

With the system 10 described herein, a residential or other noncommercial charging station 20 may be equipped to permit payment by a user for electricity used to charge a vehicle. Such noncommercial charging stations (or charging interfaces, which may be simple plug or electrical outlet) do not include built-in, direct payment interfaces like a credit card reader or direct electronic payment interface, like an Apple Pay device, or the like, and so there is no direct way to calculate an amount to be paid, or to collect payment from users. The system 10 may be flexibly implemented to permit users to determine a monetary amount to pay, to calculate a monetary amount based on the actual cost of the electricity or based on an agreed to or preset electricity cost. The charging station 20 may be equipped with a communication device 24 for direct connection to a remote device or system, like the backend portion 60 of the cloud-based system noted above, and may control payment via the backend portion. In addition to or instead, the system may utilize a third-party payment system to enable the payment transaction. In this way, fair payment may be made for use of a noncommercial charging station 20.

What is claimed is:

1. A vehicle charging system, comprising:
a power supply connected to the electrical system of a personal residence, the power supply including a charging station adapted to be connected to a vehicle to permit charging of a power storage unit in the vehicle;
a power meter adapted to determine an amount of electricity used to charge the vehicle in a charging session; and
a communication device adapted to connect with a remote electronic device, the communication device having a transmitter that provides an output indicative of the amount of electricity used to charge the vehicle in the charging session, the communication device having a receiver adapted to receive information from the remote electronic device, and the communication device has a control interface by which the payment information is adapted to be transferred to transfer funds to a recipient as a function of the amount of electricity used to charge the vehicle.

2. The system of claim 1 wherein the power supply is an electrical system of a residence.

3. The system of claim 2 wherein the power meter is part of a charging station at the residence.

4. The system of claim 2 wherein the power meter is part of the electrical system of the residence.

5. The system of claim 3 wherein the control interface is adapted to communicate with a third-party payment service to permit a transfer of funds to the payment recipient device via the third-party payment service.

6. The system of claim 5 wherein the control interface includes a controller and memory including instructions for communication with the remote electronic device and the third-party payment service.

7. The system of claim 5 wherein the third-party payment service includes a credit card, debit card, digital wallet or peer-to-peer payment service.

8. The system of claim 1 which also includes a remote system having a backend portion configured to communicate with the communication device for exchange of information between the communication device and the backend portion.

9. The system of claim 8 wherein the remote system having the backend portion is part of a secure, cloud-based network adapted to communicate with the communication device to receive information from the communication device about a charging session.

10. A method of determining and effecting payment for use of a personal vehicle charging station, comprising:
determining an amount of electricity used to charge the vehicle power storage system in a charging session;
determining a monetary amount for the amount of electricity used to charge the vehicle power storage system in the charging session;
requesting from a remote electronic device payment of the monetary amount; and
providing an interface for payment of the monetary amount from the remote electronic device to a recipient.

11. The method of claim 10 wherein the interface includes one or more of a credit card portal, debit card portal, digital wallet portal or peer-to-peer payment service.

12. The method of claim 10 wherein the step of determining an amount of electricity used to charge the vehicle power storage system in a charging session is accomplished by connection of a remote electronic device with a power meter, where the power meter provides to the remote electronic device an output indicative of the amount of electricity used to charge the vehicle power storage system in a charging session.

13. The method of claim 12 wherein the step of determining a monetary amount for the amount of electricity used to charge the vehicle power storage system in the charging session is accomplished by reference to an established cost for the electricity used to charge the vehicle power storage system in the charging session.

14. The method of claim 13 wherein the established cost may be stored in a memory device, available in a remote database, or entered manually into a device used to determine the monetary amount.

15. The method of claim 14 wherein the device used to determine the monetary amount includes a mobile phone, tablet or personal computing device.

16. The method of claim 15 wherein the interface is provided on the mobile phone, tablet or personal computing device.

17. The method of claim 15 wherein the interface permits manual entry of the monetary amount.

18. The method of claim 12 wherein the power meter is a vehicle control system that controls the rate at which charging of the vehicle power storage system occurs, and wherein the remote electronic device is communicated with the vehicle control system.

19. The method of claim 18 wherein the remote electronic device is connected with the vehicle control system via a wireless local area network or by a wired connection of the device to a port of the vehicle.
